(19) United States
(12) Patent Application Publication
(10) Pub. No.: US 2023/0030954 A1
(43) Pub. Date: Feb. 2, 2023

(54) Rake Device

(71) Applicant: Robert W. McQuade, JR., Millville, NJ (US)

(72) Inventor: Robert W. McQuade, JR., Millville, NJ (US)

(21) Appl. No.: 17/845,994

(22) Filed: Jun. 21, 2022

Related U.S. Application Data
(60) Provisional application No. 63/178,523, filed on Apr. 22, 2021.

(51) Int. Cl. A01D 7/04

(52) U.S. Cl. CPC A01D 7/04

(57) ABSTRACT

One aspect of the present invention is a rake spline separator for minimizing or preventing movable or adjustable rake splines from getting damaged and/or from being moved or bent to inefficient raking positions during raking tasks. As a non-limiting embodiment or example, the rake spline separator includes a first end, a second end, an elongated body extending from the first end to the second end, a first or front side, a second or rear side, and a plurality of holes. Another aspect of the present invention is a rake-assisting apparatus that includes a rake spline separator and a rake scoop device. A further aspect of the present invention is a rake that includes a rake spline separator and that may also include a rake scoop device.

### CROSS-REFERENCE TO RELATED APPLICATIONS

The present application claims the priority benefit of U.S. Provisional Patent Application Ser. No. 63/178,523, filed on Apr. 22, 2021 and titled “The Leaf Stopper,” which is incorporated herein by reference in its entirety.

### BACKGROUND OF THE INVENTION

### Field of the Invention

The present invention generally relates to rakes, tools similar to rakes, and devices for helping rakes and similar tools carry out raking tasks, such as lawn work or lawn care. More specifically, one aspect of the present invention is a rake spline separator for minimizing or preventing movable or adjustable rake splines from getting damaged and/or from being moved or bent to inefficient raking positions during raking tasks. Another aspect of the present invention is a rake-assisting apparatus that includes a rake spline separator and a rake scoop device. A further aspect of the present invention is a rake that includes a rake spline separator and that may also include a rake scoop device.

### Description of the Related Art

Rakes, tools similar to rakes, and devices for helping rakes and similar tools carry out raking tasks are known in the art.

One aspect of the present invention is a rake spline separator for minimizing or preventing movable or adjustable rake splines from getting damaged and/or from being moved or bent to inefficient raking positions during raking tasks.

The present invention overcomes one or more of the shortcomings of rakes, tools similar to rakes, and devices for helping rakes and similar tools carry out raking tasks. The Applicant is unaware of inventions or patent documents, taken either singly or in combination, which are seen to describe the present invention as claimed.

One advantage of the rake spline separator is that it helps to minimize or prevent movable or adjustable rake splines from getting damaged and/or from being moved or bent to inefficient raking positions during raking tasks.

Another advantage of the rake spline separator is that it helps owners of rakes with movable or adjustable rake splines save money due to not having to replace or fix the rake splines and/or rakes as often.

### SUMMARY OF THE INVENTION

One aspect of the present invention is a rake spline separator for minimizing or preventing movable or adjustable rake splines from getting damaged and/or from being moved or bent to inefficient raking positions during raking tasks. As a non-limiting embodiment or example, the rake spline separator includes a first end, a second end, an elongated body extending from the first end to the second end, a first or front side, a second or rear side, a plurality of holes, a first or top edge, and a second or bottom edge.

Another aspect of the present invention is a rake-assisting apparatus that includes a rake spline separator and a rake scoop device. A further aspect of the present invention is a rake that includes a rake spline separator and that may also include a rake scoop device.

### BRIEF DESCRIPTION OF THE DRAWINGS

FIG. 1 is a rear, perspective view of an embodiment of a rake spline separator according to the present invention;

FIG. 2 is a front, right side, perspective view of the rake spline separator of FIG. 1;

FIG. 3 is a right side, perspective view of an embodiment of a rake scoop device according to the present invention;

FIG. 4 is an environmental, front, perspective view of an embodiment of a rake-assisting apparatus according to the present invention, wherein the apparatus includes a rake spline separator and a rake scoop device;

FIG. 5 is an environmental, top view of the rake-assisting apparatus of FIG. 4;

FIG. 6 is an environmental, cross-sectional view of the rake-assisting apparatus of FIG. 4;

FIG. 7 is a front, perspective view of an embodiment of a rake according to the present invention, wherein the rake includes a rake spline separator;

FIG. 8 is an environmental, front, perspective view of the rake of FIG. 7;

FIG. 9 is a front, perspective view of an embodiment of a rake according to the present invention, wherein the rake includes a rake spline separator and a rake scoop device; and

FIG. 10 is an environmental, front, perspective view of the rake of FIG. 9.

It should be understood that the above-attached figures are not intended to limit the scope of the present invention in any way.

### DETAILED DESCRIPTION OF THE EMBODIMENTS AND ASPECTS OF THE PRESENT INVENTION

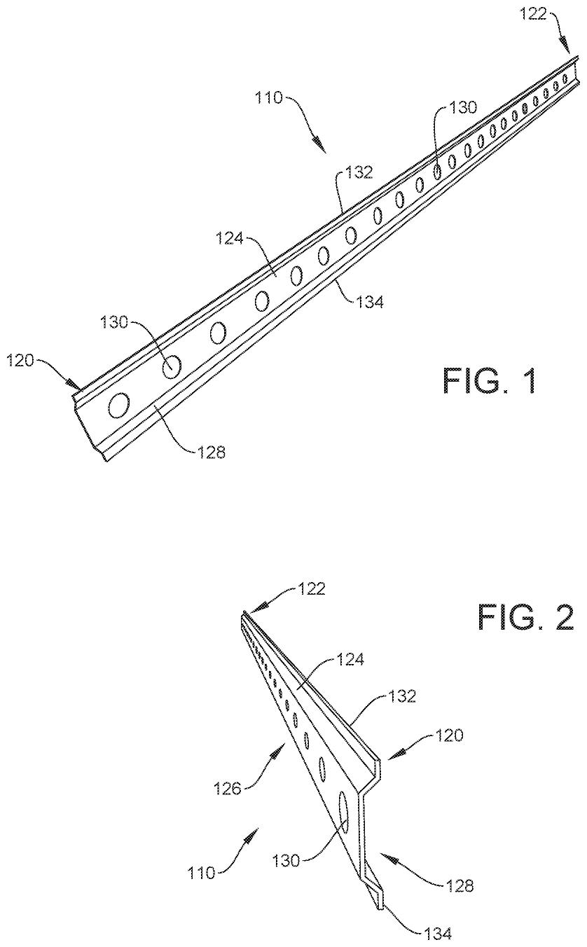

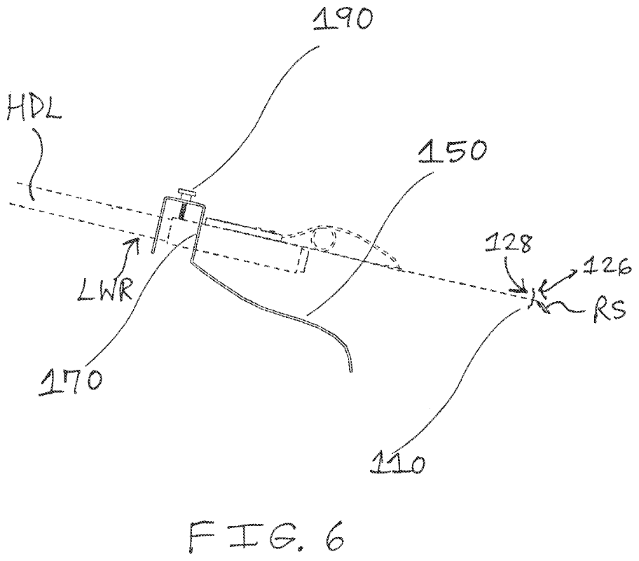

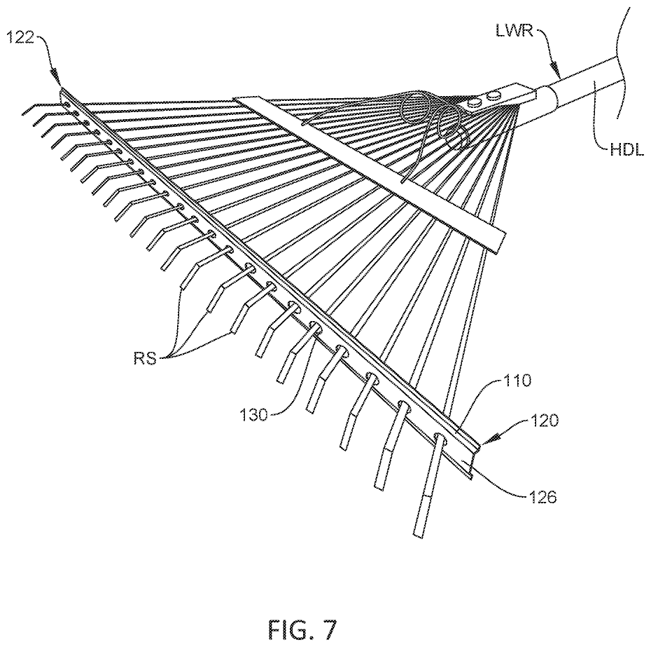

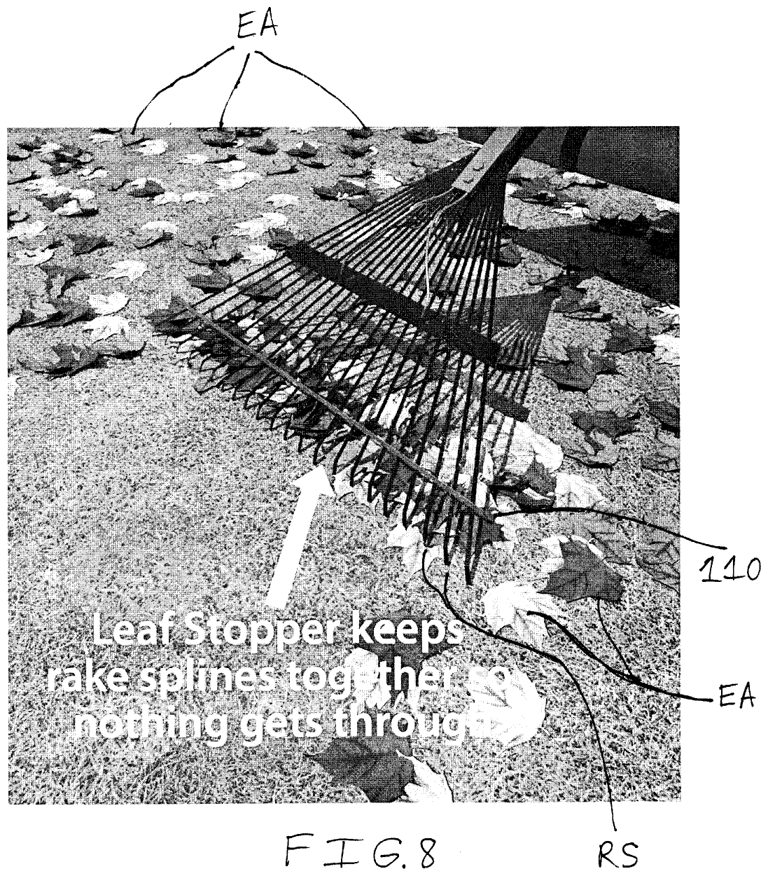

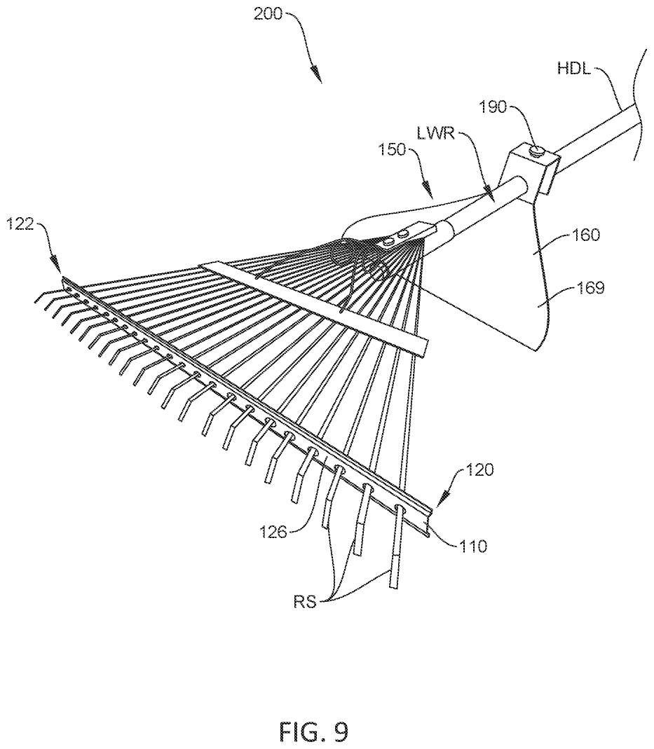

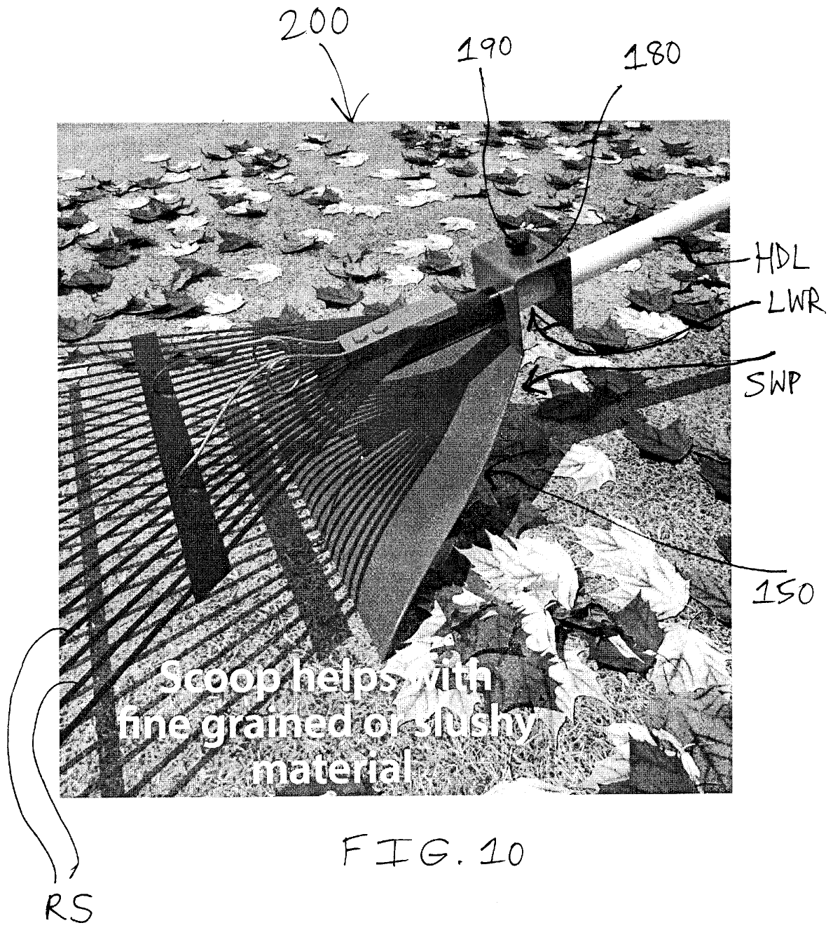

Referring to FIGS. 1-10, one aspect of the present invention is a rake spline separator 110. Another aspect of the present invention is a rake-assisting apparatus that includes a rake spline separator 110 and a rake scoop device 150. A further aspect of the present invention is a rake 200 that includes a rake spline separator 110 and that may also include a rake scoop device 150.

The rake spline separator 110 is for minimizing or preventing movable or adjustable rake splines RS from getting damaged (such as, but not limited to, bent, broken or separated from an applicable rake) and/or from being moved or bent to inefficient raking positions during raking tasks, such as, but not limited to, lawn work or lawn care, as a result of the movable or adjustable rake splines RS making contact with the ground and/or environmental articles EA, such as, but not limited to, leaves, cut grass, branches, twigs, rocks, and small animals. Thus, this rake spline separator 110, when preferably positioned, engaged or secured to or about a lower end of an applicable rake, such as, but not limited to, a poly leaf rake having a plurality of movable or adjustable rake splines RS, and also to the lower ends of the movable or adjustable rake splines RS, helps the user to perform raking tasks more efficiently in many instances when compared to a similar poly leaf rake not having a rake spline separator 110 secured, engaged or attached to the movable or adjustable rake splines RS. For use, the rake spline separator 110 may be slid through the lower ends of the movable or adjustable rake splines RS and moved upward toward the upper end of the handle of the rake until the rake spline separator 110 is sufficiently secured or engaged with the movable or adjustable rake splines RS.

As best shown in FIGS. 1, 2, 4, 7 and 9 and as a non-limiting example, the rake spline separator 110 includes a first end 120, a second end 122, an elongated body 124 extending from the first end 120 to the second end 122, a first or front side 126, a second or rear side 128, a plurality of holes 130, a first or top edge 132, and a second or bottom edge 134. The elongated body 124 is raised or extended from the first or top edge 132 and second or bottom edge 134 such that it creates functional stops or securing mechanisms (without the need for additional components and/or parts) when the rake spline separator 110 is secured, engaged or attached to the movable or adjustable rake splines RS. As non-limiting examples, the elongated body 124 may have a planar axis to accommodate certain applicable rakes where the configuration of the movable or adjustable rake splines RS is “V-shaped,” or may have a curved or semi-circular axis to accommodate other applicable rakes where the configuration of the movable or adjustable rake splines RS is “fan-shaped.”

Preferably, the rake spline separator 110 is made or manufactured to have a sufficient length to accommodate some, many, most or all applicable rakes having a plurality of movable or adjustable rake splines RS. As non-limiting examples, the rake spline separator 110 can be made or manufactured and sold in different lengths to accommodate most or all applicable rakes, or can be made or manufactured and sold in one single length such that it has at least one perforated section or a section that can be cut out or reduced to shorten the length to accommodate most or all applicable rakes. Preferably, the rake spline separator 110 is made or manufactured of a plastic material, a metal material, aluminum, a wood material, and any combination thereof. Preferably, the rake spline separator 110 is made or manufactured of a rustproof or rust-resistant material.

Preferably, the plurality of holes 130 are evenly-spaced along the elongated body member 120. Each of the plurality of holes 130 is dimensioned and configured for receiving a corresponding rake spline RS of the applicable rake RK and, during use, for retaining the corresponding rake spline RS within a predetermined or certain distance from an original or efficient working position OP, such that the corresponding rake spline RS is prevented from being damaged and/or sufficiently moved or bent away from the original or efficient working position OP. Thus, the user is able to perform work in an efficient manner due to the environmental articles being prevented from readily passing through spaces between two adjacent rake splines RS and making the user perform extra raking to be able to gather the missed environmental articles.

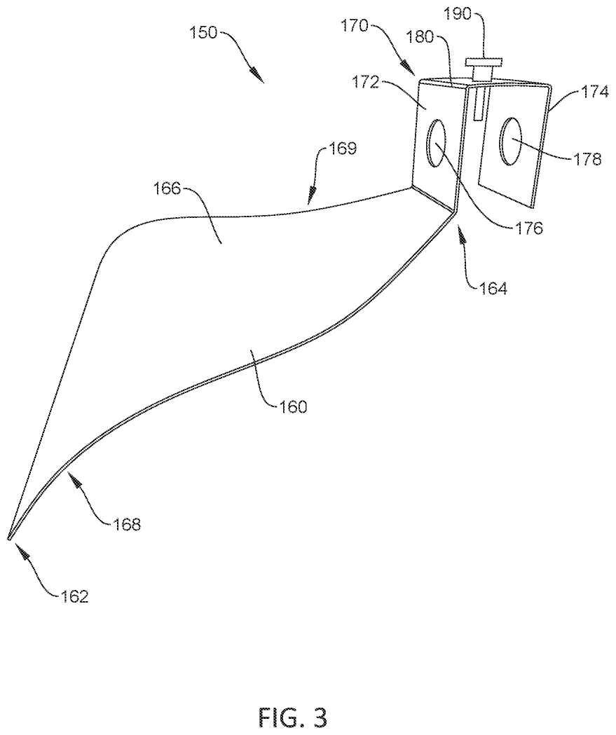

As best shown in FIGS. 3-5, 9 and 10 and as a non-limiting example, the rake scoop device 150 includes a scoop 160, a scoop-rake connecting portion or member 170, and a securing device or member 190 (such as, but not limited to, a tightening bolt that is threaded). For use, the scoop 160 and scoop-rake connecting portion or member 170 may be slid through the upper end UPP of the elongated handle HDL of the rake RK and moved downward toward the lower end LWR of the elongated handle HDL of the rake RK and stopping at a scoop work position SWP to be secured by the tightening bolt 190.

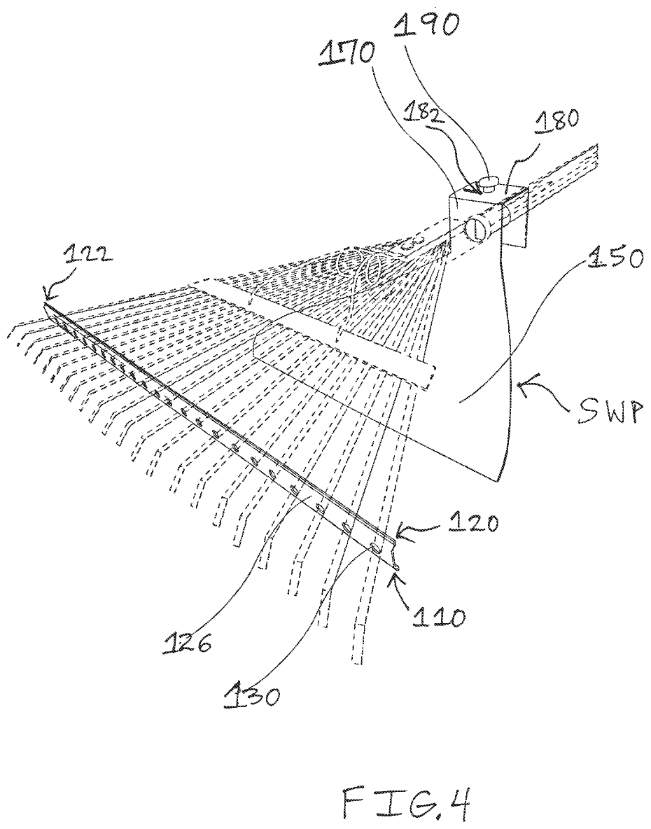

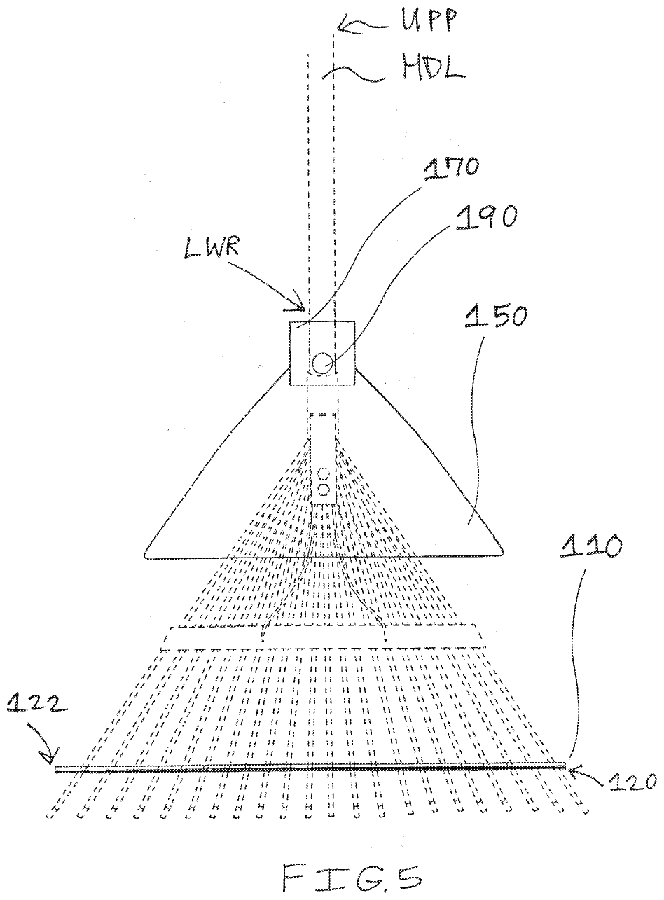

As a non-limiting example, the scoop 160 includes a first or lower end 162, a second or upper end 164, and a body 166 extending from the lower end 162 to the upper end 164. The body 166 of the scoop 160 has a first or scoop side 168 and a second or push side 169. The scoop 160 is dimensioned and configured to raking and/or scooping environmental articles that are of finer grained material or slushy wet material, like wet leaves or grass. Due to the configuration of the upper end 164 of the scoop 160, the scoop 160 is able to be rotated about three hundred and sixty degrees such that it can be rotated into or remain at the scoop work position SWP (shown in FIGS. 4 and 10) and possibly one or more scoop non-work position(s), such as, but not limited to, a position that is ninety degrees or 180 degrees from the scoop work position SWP.

As a non-limiting example, the scoop-rake connecting portion or member 170 is configured like a bracket and the like. The scoop-rake connecting portion or member 170 includes a pair of opposing sides 172,174 with a pair of opposing holes or apertures 176,178 dimensioned for receiving and allowing a lower end of an elongated handle of a rake to pass through, and also includes a top side 180 with a hole or aperture 182 dimensioned, configured and preferably threaded for receiving and allowing the tightening bolt 190 to secure the scoop 160 to the rake.

Preferably, each of the scoop 160 and scoop-rake connecting portion or member 170 is made or manufactured of a plastic material, a metal material, aluminum, a wood material, and any combination thereof. Preferably, each of the scoop 160 and scoop-rake connecting portion or member 170 is made or manufactured of a rustproof or rust-resistant material.

It is to be understood that the present invention is not limited to the embodiments described above or as shown in the attached figures, but encompasses any and all embodiments within the spirit of the invention.

1. A rake spline separator for being secured to a lower end of an applicable rake, said rake spline separator comprising:
a first end, a second end, an elongated body extending from said first end to said second end, a front side, a rear side, and a plurality of holes,
wherein said plurality of holes are spaced along said rake spline separator from said first end to said second end, and
wherein each of said plurality of holes is dimensioned and configured for receiving a corresponding rake spline of the applicable rake and, during use, for retaining the corresponding rake spline within a predetermined distance from an original or efficient working position such that the corresponding rake spline is prevented from being damaged and/or sufficiently moved away from the original or efficient working position and such that a user is able to perform work in an efficient manner.

2. The rake spline separator according to claim 1, wherein said plurality of holes are evenly-spaced along said elongated body member.

3. The rake spline separator according to claim 1, wherein said rake spline separator further comprises a first edge and a second edge.

4. The rake spline separator according to claim 1, wherein said rake spline separator is generally planar from said first end to said second end.

5. The rake spline separator according to claim 1, wherein said rake spline separator has a semi-circular configuration from said first end to said second end.

6. The rake spline separator according to claim 1, wherein said rake spline separator is made of a material selected from the group consisting of a plastic material, a metal material, aluminum, a wood material, and any combination thereof.

7. A rake comprising:
a handle comprising a first end and a second end;
a rake spline unit secured about said second end of said handle,
wherein said rake spline unit comprises a plurality of rake splines; and
a rake spline separator secured to a lower end of an applicable rake,
wherein said rake spline separator comprises an elongated body member that comprises a first end, a second end, a front side, a rear side, and a plurality of holes,
wherein said plurality of holes are spaced along said elongated body member, and
wherein each of said plurality of holes is dimensioned and configured for receiving a corresponding rake spline and, during use, for retaining said corresponding rake spline within a predetermined distance from an original position such that said corresponding rake spline is prevented from being damaged and such that work by a user is being performed in an efficient manner.

8. The rake according to claim 7, wherein said plurality of holes are evenly-spaced along said elongated body member.

9. The rake according to claim 7, wherein said elongated body member further comprises a first edge and a second edge.

10. The rake according to claim 7, wherein said elongated body member is generally planar from said first end to said second end.

11. The rake according to claim 7, wherein said elongated body member has a semi-circular configuration from said first end to said second end.

12. The rake according to claim 7, wherein said elongated body member is made of a material selected from the group consisting of a plastic material, a metal material, aluminum, a wood material, and any combination thereof.

13. The rake according to claim 7, further comprising a rake scoop device, wherein said rake scoop device is positioned about said second end of said handle during use of scooping materials.

14. The rake according to claim 13, wherein said rake scoop device comprises a scoop, a scoop-rake connecting portion or member, and a securing device or member.

15. The rake according to claim 14, wherein said scoop comprises a first or lower end, a second or upper end, and a body extending from said lower end to said upper end of said scoop, wherein said body of said scoop comprises a first or scoop side and a second or push side.

16. The rake according to claim 15, wherein said scoop is able to be rotated about three hundred and sixty degrees such that it can be rotated into or remain at a scoop work position and at least one scoop non-work position.

17. The rake according to claim 13, wherein said scoop-rake connecting portion or member is configured like a bracket and the like.

18. The rake according to claim 17, wherein said scoop-rake connecting portion or member comprises a pair of opposing sides with a pair of opposing holes or apertures dimensioned for receiving and allowing said lower end of said handle to pass through, and a top side with a hole or aperture dimensioned and configured for receiving and allowing said securing device or member to secure said scoop to said rake.

19. The rake according to claim 13, wherein at least one of said scoop and said scoop-rake connecting portion or member is made or manufactured of a material selected from the group consisting of a plastic material, a metal material, aluminum, a wood material, and any combination thereof.

20. The rake according to claim 13, wherein at least one of said scoop and said scoop-rake connecting portion or member is made or manufactured of a rustproof or rust-resistant material.
